(19) United States
(12) Patent Application Publication
(10) Pub. No.: US 2002/0161998 A1
(43) Pub. Date: Oct. 31, 2002

(54) Method and system for providing hardware cryptography functionality to a data processing system lacking cryptography hardware

(75) Inventors: Daryl Carvis Cromer, Apex, NC (US); Howard Jeffrey Locker, Cary, NC (US); Andy Lloyd Trotter, Raleigh, NC (US); James Peter Ward, Raleigh, NC (US)

Correspondence Address: BRACEWELL & PATTERSON, L.L.P., INTELLECTUAL PROPERTY LAW, P.O. BOX 969, AUSTIN,, TX, 78767-0969, US

(73) Assignee: International Business Machines Corporation

(21) Appl. No.: 09/844,734

(22) Filed: Apr. 27, 2001

(51) Int. Cl. H04L 9/00

(52) U.S. Cl. 713/153

(57) ABSTRACT

A client lacking hardware-based cryptography functionality obtains its benefits by allowing an access server (or similar server through which the client consistently transmits data transactions) which has such hardware-based cryptography functionality to act as a virtual client. A connection having packet-level encryption is employed to transmit data transaction requests, and optionally also encryption keys, digital certificates and the like assigned to the client, from the client to the server, and to transmit processed responses from the server to the client. The server performs any required security processing required for data transaction requests and responses, such as encryption/decryption or attachment or validation of digital certificates, on behalf of the client utilizing the hardware-based cryptography functionality, then forwards processed requests to recipients and returns processed responses to the client via the secure connection.

### BACKGROUND OF THE INVENTION

1. Technical Field

The present invention generally relates to data communication security and in particular to achieving hardware-based performance levels for data encryption. Still more particularly, the present invention relates to emulating hardware-based data encryption for systems which lack hardware encryption units.

2. Description of the Related Art

As security becomes an increasingly prevalent concern in the networking and data communications industries, eventually all data communications will be required to be secure. The encryption algorithms which provide data security, such as the Data Encryption Standard (DES), Rivest-Shamir-Edelman Algorithm (RSA), and Message-Digest Algorithm 5 (MD-5), are all computationally intensive algorithms. Performing these encryption functions in hardware improves the speed of encryption and minimizes the impact to other applications. Security functions optimized to run in hardware far outperform any software implementation. Additionally, securely storage of private keys in hardware eliminates the chance of a third party stealing a person's or client application's identity for spoofing.

The primary disadvantage of hardware implementation of encryption is the added costs—space, power, and production costs—associated with the requisite hardware. Nonetheless, many new data processing systems currently being sold include hardware support for generation and secure storage of encryption keys and encrypted data. As the implementation of hardware-based encryption in data processing systems becomes more prevalent and come to be expected by other data processing systems (e.g., data servers), an equivalent level of functionality is required for interoperability with “legacy” or entry level (“low-cost solution”) data processing systems which do not have these hardware encryption capabilities, as well as systems which cannot support space and/or power requirements for the additional hardware (e.g., personal digital assistants or mobile telephones).

It would be desirable, therefore, to provide a data processing system with all of the capabilities of a secure hardware-based cryptographic unit without adding the hardware.

### SUMMARY OF THE INVENTION

It is therefore one object of the present invention to provide improved data communication security.

It is another object of the present invention to provide hardware-based performance levels for data encryption.

It is yet another object of the present invention to provide emulation of hardware-based data encryption for systems which lack hardware encryption units.

The foregoing objects are achieved as is now described. A client lacking hardware-based cryptography functionality obtains its benefits by allowing an access server (or similar server through which the client consistently transmits data transactions) which has such hardware-based cryptography functionality to act as a virtual client. A connection having packet-level encryption is employed to transmit data transaction requests, and optionally also encryption keys, digital certificates and the like assigned to the client, from the client to the server, and to transmit processed responses from the server to the client. The server performs any required security processing required for data transaction requests and responses, such as encryption/decryption or attachment or validation of digital certificates, on behalf of the client utilizing the hardware-based cryptography functionality, then forwards processed requests to recipients and returns processed responses to the client via the secure connection.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a data processing system network providing a virtual client in accordance with a preferred embodiment of the present invention;

FIG. 2 is a block diagram showing additional details of the data processing system network providing a virtual client in accordance with a preferred embodiment of the present invention; and

FIG. 3 is a high-level flow chart for a process of providing a virtual client in accordance with a preferred embodiment of the present invention.

### DETAILED DESCRIPTION OF THE PREFERRED EMBODIMENT

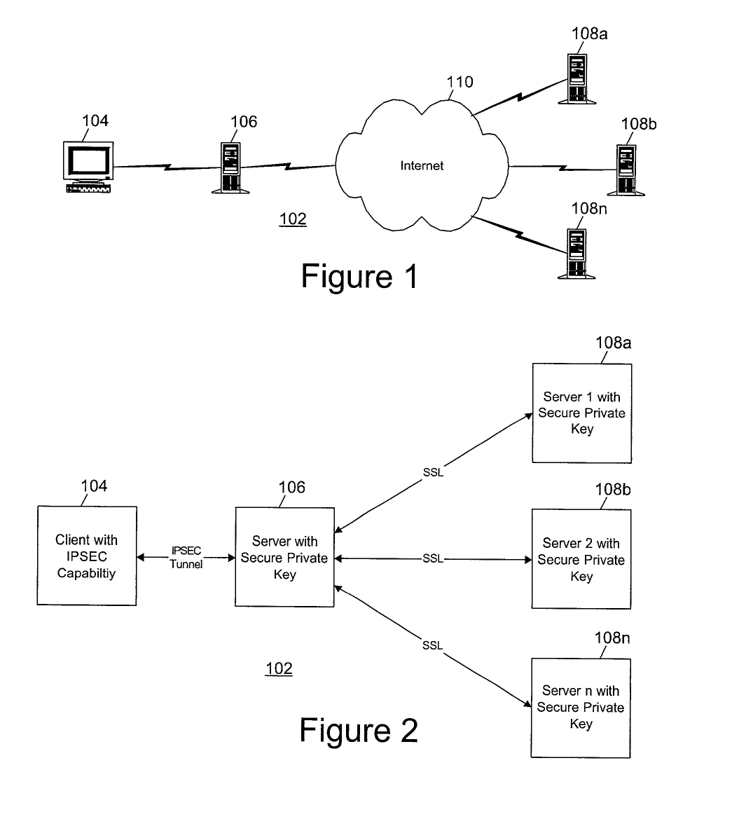

With reference now to the figures, and in particular with reference to FIG. 1, a data processing system network providing a virtual client in accordance with a preferred embodiment of the present invention is depicted. Data processing system network 102 includes a client system 104 and a server system 106. Client system 104 (also known as a “thin client”) does not include encryption hardware, but consistently utilizes a server 106 having cryptography hardware for access to one or more other servers 108a-108n via a data network, such as Internet 110. Although depicted as a computer system, client system 104 (and servers 106 and 108) may be any type of system employing data communications, including a personal digital assistant, mobile telephone, and the like.

The structure and operation of data processing system network 104 is well known in the relevant art, and only so much of the structure and operation of data processing system as is unique to the present invention and/or required for an understanding of the present invention will be described herein.

Referring to FIG. 2, a block diagram showing additional details of the data processing system network providing a virtual client in accordance with a preferred embodiment of the present invention is illustrated. In the present invention, client 104 and server 106 within data processing system network 102 are capable of communicating via a protocol employing packet-level encryption. Although any protocol supporting packet-level encryption may be utilized in accordance with the present invention, the remainder of the specification will be described with reference to a preferred embodiment in which the IP Security (IPSEC) protocol described in the draft standard available at www.ietf.org/html.charters/ipsec-charter.html is employed. In this preferred embodiment, client 104 and server 106 preferably communicate while operating in the IPSEC tunnel mode.

When client 104 opens an application (e.g., a Web browser or email application) to initiate communication, an IPSEC tunnel is connected to server 106 and user information (public/private keys, certificates, etc.) is securely transmitted to server 106 via the IPSEC tunnel. Client 104 preferably stores such user information in encrypted format so that keys and/or other user information are not in the clear and can only be decrypted by the encryption hardware of server 106. Server 106 then acts as a virtual client for client 104, performing in hardware any required cryptography on behalf of client 104 in data transactions with servers 108a-108n (or other data processing systems). The operations performed by server 106 on behalf of client 102 are performed in the cryptography hardware of server 106 so that security is not compromised by storing the user information in system memory or other non-secure storage.

For example, when client 104 attempts to make a secure connection to a Web address using SSL, the address is first transmitted to the server 106 via the IPSEC connection. The server 106 will then contact the secure Web site referenced by the Web address using a Secure Sockets Layer (SSL) connection, performing all necessary cryptographic functions necessary to retrieve data from the reference Web site on behalf of the client 104. Server 106 will also validate all data returned by the referenced Web site, including any digital signatures and the like. The returned data is then securely transmitted back to the client 104 by the server 106 via the IPSEC tunnel connection. The process is seamless for client 104, appearing to external systems (other than server 106) that all functions are performed on the client 104 and that all data originates from and is securely returned to the client 104.

Of course, secure communication with a remote server 108 through server 106 need not employ an SSL connection. For example, if client 104 needed to send digitally signed and encrypted email, server 106 would perform all cryptographic operations on behalf of client 104 and transmit the email to another data processing system, as represented by server 108.

Encrypted security parameters specific to the client 104 (e.g., public and/or private encryption keys, digital certificates, and the like) may be passed to the server 106 from the client 104 via the IPSEC connection for each browsing session on the client 104, or alternatively may be maintained securely within the server 106 for ease of use on a regular basis.

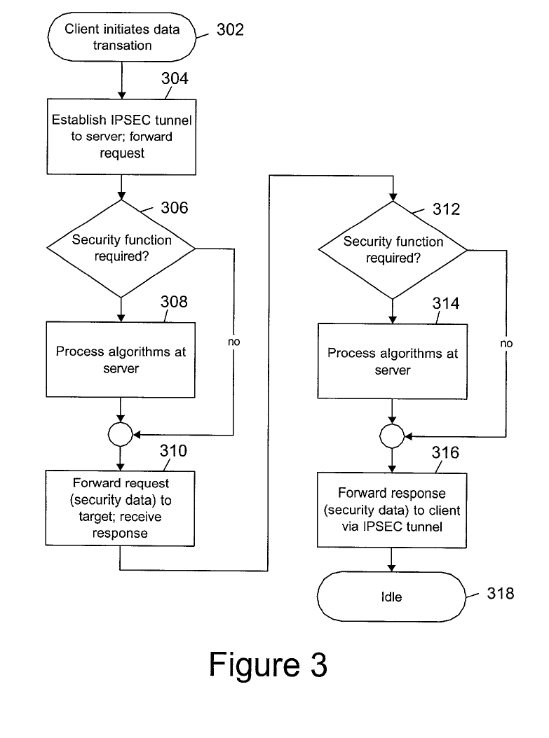

With reference now to FIG. 3, there is illustrated a high level flowchart of a process of communication through a virtual client in accordance with a preferred embodiment of the present invention. The process begins at step 302, which illustrates the client initiating a data transaction. The process passes first to step 304, which illustrates establishing a secure connection, if necessary, between the client and an access server or similar type of server through which the client consistently communicates. As discussed above, the secure connection can employ IPSEC or any other protocol supporting packet-level encryption. The process then passes to step 306, which depicts a determination of whether a security function is required for the requested data transaction, such as encryption or attachment of a digital signature.

If a security function is required for the requested data transaction, the process proceeds to step 308, which illustrates processing any necessary security algorithms (e.g., encryption algorithms and the like) within the server, utilizing hardware-based cryptography functionality available within the server. The process passes next to step 310, which depicts forwarding the requested data transaction, in a required security format (e.g., encrypted) and/or together with any necessary security data (e.g., a digital signature) to the target of the requested data transaction via a secure (e.g., SSL) communication (if required), and receiving a response from the target of the requested data transaction via a secure communication (if required).

The process then passes to step 312, which illustrates a determination of whether a security function is required for the received response, such as decryption or validation of a digital signature. If a security function is required by the response, the process proceeds to step 314, which illustrates processing any necessary security algorithms within the server utilizing the available hardware-based cryptography functionality within the server. The process passes next to step 316, which depicts returning the received response, together with any results from the security processing (e.g., validation error), to the client via the secure (e.g., IPSEC) connection. The process then passes to step 318, which illustrates the process becoming idle until another data transaction is initiated by the client.

The present invention allows cryptographic functions to be securely shifted from a client to an access server or the like, extending the benefits of hardware-based security functionality to legacy data processing systems and low cost, low power, or devices which are otherwise constrained and therefore lack the requisite hardware.

It is important to note that while the present invention has been described in the context of a fully functional data processing system and/or network, those skilled in the art will appreciate that the mechanism of the present invention is capable of being distributed in the form of a computer usable medium of instructions in a variety of forms, and that the present invention applies equally regardless of the particular type of signal bearing medium used to actually carry out the distribution. Examples of computer usable mediums include: nonvolatile, hard-coded type mediums such as read only memories (ROMs) or erasable, electrically programmable read only memories (EEPROMs), recordable type mediums such as floppy disks, hard disk drives and CD-ROMs, and transmission type mediums such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method of secure communication, comprising:
receiving a request for a data transaction from a client lacking hardware cryptography functionality, together with security parameters specific to the client, at a server through a secure connection between the client and the server;
performing any necessary security processing for the requested data transaction within the server on behalf of the client utilizing hardware cryptography functionality available within the server; and
after performing any necessary security processing on the requested data transaction, forwarding the processed data transaction to a target of the requested data transaction as if originating from the client.

2. The method of claim 1, wherein the step of receiving a request for a data transaction from a client lacking hardware cryptography functionality, together with security parameters specific to the client, at a server through a secure connection between the client and the server further comprises:
receiving the requested data transaction through an IPSEC connection.

3. The method of claim 1, wherein the step of receiving a request for a data transaction from a client lacking hardware cryptography functionality, together with security parameters specific to the client, at a server through a secure connection between the client and the server further comprises:
receiving encryption keys or a digital certificate assigned to the client.

4. The method of claim 1, wherein the step of performing any necessary security processing for the requested data transaction within the server on behalf of the client utilizing hardware cryptography functionality available within the server further comprises:
encrypting data within the requested data transaction; or
generating a digital signature for attachment to the data transaction.

5. The method of claim 1, wherein the step of forwarding the processed data transaction to a target of the requested data transaction as if originating from the client further comprises:
forwarding the processed data transaction via an SSL transaction.

6. The method of claim 1, further comprising:
receiving a response to the processed data transaction at the server;
performing any security processing required by the response; and
forwarding the processed response, together with any results of the security processing, to the client via the secure connection.

7. The method of claim 6, wherein the step of performing any security processing required by the response further comprises:
decrypting the received response; or
validating a digital signature attached to the received response.

8. A system for secure communication, comprising:
a client lacking hardware cryptography functionality;
a server including hardware cryptography functionality;
a secure Internet Protocol connection between the client and the server;
means for receiving a request for a data transaction from the client, together with security parameters specific to the client, at the server through the secure connection;
means for performing any necessary security processing for the requested data transaction within the server on behalf of the client utilizing the hardware cryptography functionality available within the server; and
means, responsive to completion of performing any necessary security processing on the requested data transaction, for forwarding the processed data transaction to a target of the requested data transaction as if originating from the client.

9. The system of claim 8, wherein secure connection further comprises:
an IPSEC connection.

10. The system of claim 8, wherein the means for receiving a request for a data transaction from the client, together with security parameters specific to the client, at the server through the secure connection further comprises:
means for securely receiving encryption keys or a digital certificate assigned to the client.

11. The system of claim 8, wherein the means for performing any necessary security processing for the requested data transaction within the server on behalf of the client utilizing hardware cryptography functionality available within the server further comprises:
means for encrypting data within the requested data transaction; or
means for generating a digital signature for attachment to the data transaction.

12. The system of claim 8, wherein the means for forwarding the processed data transaction to a target of the requested data transaction as if originating from the client further comprises:
means for forwarding the processed data transaction via an SSL transaction.

13. The system of claim 8, further comprising:
means for receiving a response to the processed data transaction at the server;
means for performing any security processing required by the response; and
means for forwarding the processed response, together with any results of the security processing, to the client via the secure connection.

14. The system of claim 13, wherein the means for performing any security processing required by the response further comprises:
means for decrypting the received response; or
means for validating a digital signature attached to the received response.

15. A computer program product within a computer usable medium for secure communication, comprising:
instructions for receiving a request for a data transaction from a client lacking hardware cryptography functionality, together with security parameters specific to the client, at a server through a secure connection between the client and the server;
instructions for performing any necessary security processing for the requested data transaction within the server on behalf of the client utilizing hardware cryptography functionality available within the server; and
instructions, responsive to completion of performing any necessary security processing on the requested data transaction, for forwarding the processed data transaction to a target of the requested data transaction as if originating from the client.

16. The computer program product of claim 15, wherein the instructions for receiving a request for a data transaction from a client lacking hardware cryptography functionality, together with security parameters specific to the client, at a server through a secure connection between the client and the server further comprise:
instructions for receiving the requested data transaction through an IPSEC connection.

17. The computer program product of claim 15, wherein the instructions for receiving a request for a data transaction from a client lacking hardware cryptography functionality, together with security parameters specific to the client, at a server through a secure connection between the client and the server further comprise:
instructions for securely receiving encryption keys or a digital certificate assigned to the client.

18. The computer program product of claim 15, wherein the instructions for performing any necessary security processing for the requested data transaction within the server on behalf of the client utilizing hardware cryptography functionality available within the server further comprise:
instructions for encrypting data within the requested data transaction; or
instructions for generating a digital signature for attachment to the data transaction.

19. The computer program product of claim 15, wherein the instructions for forwarding the processed data transaction to a target of the requested data transaction as if originating from the client further comprises:
instructions for forwarding the processed data transaction via an SSL transaction.

20. The computer program product of claim 15, further comprising:
instructions for receiving a response to the processed data transaction at the server;
instructions for performing any security processing required by the response; and
instructions for forwarding the processed response, together with any results of the security processing, to the client via the secure connection.

21. The computer program product of claim 20, wherein the instructions for performing any security processing required by the response further comprise:
instructions for decrypting the received response; or
instructions for validating a digital signature attached to the received response.
